(19) United States
(12) Patent Application Publication
(10) Pub. No.: US 2021/0018591 A1
(43) Pub. Date: Jan. 21, 2021

(54) RADAR TARGET EMULATOR, TEST BENCH AND METHOD FOR SIGNAL PROCESSING

(71) Applicant: AVL LIST GMBH, Graz (AT)

(72) Inventors: Andreas GRUBER, Graz (AT); Michael Ernst GADRINGER, Graz (AT); Helmut SCHREIBER, Graz (AT); Michael VORDERDERFLER, Graz (AT)

(21) Appl. No.: 16/753,848

(22) PCT Filed: Oct. 8, 2018
(86) PCT No.: PCT/AT2018/060237

§ 371 Date: Sep. 30, 2020

(30) Foreign Application Priority Data
Oct. 6, 2017 (AT) A50858/2017

(51) Int. Cl. G01S 7/40; G01M 17/00; G01S 13/931

(52) U.S. Cl. CPC G01S 7/4052; G01M 17/00; G01S 2013/93271; G01S 2007/4065; G01S 13/931

(57) ABSTRACT

The present invention relates to a radar target emulator, a test bench having such a radar target emulator, and a method for digitally processing at least one analog radar signal. The radar target emulator comprises a first conversion apparatus configured to convert the at least one analog radar signal into at least one corresponding digital radar data packet. A data processing apparatus of the radar target emulator comprises a time delay device and a modification device, wherein the time delay device is configured to provide a plurality of delayed radar data packets on the basis of the at least one digital radar data packet. The modification device is configured to provide a plurality of modified radar data packets on the basis of the plurality of delayed radar data packets, and a second conversion apparatus is configured to provide analog processed radar signals by converting the digital radar data packets processed by the data processing apparatus. A transmission apparatus comprises at least two transmitter devices which are in particular configured to transmit the analog processed radar signals provided by the second conversion apparatus.

The present invention relates to a radar target emulator, in particular for the digital processing of at least one analog radar signal, a test bench having such a radar target emulator, and a method for digitally processing at least one analog radar signal.

The complexity of mobile systems, especially of land-based motor vehicles such as passenger cars, trucks or motorcycles, has been continuously increasing for years. In addition to reducing emissions and/or fuel consumption or increasing driving comfort, this also entails, among other things, coping with the steadily increasing volume of traffic, especially in urban centers. This is generally the purview of driver assistance systems or assistance systems respectively, these using information about the vehicle's surroundings, in particular the anticipated route, via vehicle-internal sensors and/or via communication with other vehicles and/or stationary points/services to support the driver in standard driving situations and/or extreme situations by way of notifications and/or to actively intervene in the vehicle's behavior.

Radar sensors, which monitor the immediate surroundings of the vehicle with regard to obstacles and/or vehicles driving in front or the like, are frequently used, at least as a component of the above-cited sensor system. Known for the purpose of evaluating an assistance system is furnishing same with the information ascertained by the radar sensors by way of a test scenario, in particular a virtual test scenario, and evaluating the response of the assistance system. Modulated radar signals are thereby sent to the radar sensors based on the test scenario.

The cited radar sensors are frequently pivotable in a horizontal plane (azimuth plane) and in a vertical plane (elevation plane), whereby increased spatial resolution among other things is enabled and unrealistic targets such as e.g. point targets are recognizable. To evaluate the assistance system, the radar sensors need to be sent information on the in particular virtual test scenario from different directions.

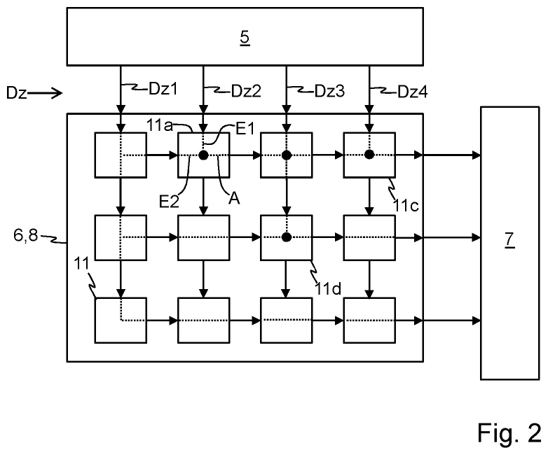

DE 38 88 993 T2 relates to an apparatus for monitoring radar performance. Here, a radar operation monitoring device is provided with a closed loop comprising a delay line arrangement in order to generate the plurality of simulated radar target object echo signals. A series of simulated radar target object echoes are generated under the control of a multiplexer control. The number of target object echoes generated is determined by the length of time that the multiplexer control enables an R-port of the multiplexer. In one exemplary embodiment, a radar operation monitoring device comprises a self-contained delay line. As a result, signals are not delayed through the delay line until a plurality of individual signals from radar target objects are generated, as is shown for example in FIG. 2 of the cited printed publication.

U.S. Pat. No. 5,247,843 relates to a system and a method for simulating electromagnetic environments, wherein an array of one or more horn antennas emits electromagnetic signals at apparent angles onto a receiving antenna.

WO 2016 02225 683 A1 relates to a method and an apparatus for determining a misalignment of a radar sensor unit, wherein an aligning device provides a plurality of targets in an arrangement and two targets in each case are aligned horizontally or respectively vertically relative to one another.

In light of the above, it is a task of the present invention to specify a radar target emulator, or a test bench having such a radar target emulator respectively, and a method for digitally processing at least one analog radar signal which improves on the prior art.

This tasked is solved in terms of the present invention by a radar target emulator according to claim 1, a test bench having such a radar target emulator as per claim 11, and a method for digitally processing at least one analog radar signal as per claim 12.

One aspect of the present invention relates to a radar target emulator, in particular for digitally processing at least one analog radar signal, which comprises a first conversion apparatus configured to convert the at least one analog radar signal into at least one corresponding digital radar data packet. Preferably, a data processing apparatus of the radar target emulator comprises a time delay device and a modification device, wherein the time delay device is in particular configured to provide a plurality of delayed radar data packets on the basis of the at least one digital radar data packet and the modification device is in particular configured to provide a plurality of modified radar data packets on the basis of the plurality of delayed radar data packets. A second conversion apparatus is preferably configured to provide analog processed radar signals by converting the digital radar data packets processed by the data processing apparatus, and a transmission apparatus comprises at least two transmitter devices which are in particular configured to transmit the analog processed radar signals provided by the second conversion apparatus.

A “radar target emulator” within the meaning of the present invention is in particular an apparatus for stimulating a radar sensor, in particular a vehicle, which preferentially receives a radar signal emitted by the radar sensor, modifies radar data packets generated on the basis of the radar signal and sends them back to the sensor as a processed radar signal. The modification preferably images a test scenario, in particular a virtual test scenario, for instance for determining and evaluating how a vehicle control unit responds to the test scenario. In this sense, a radar target emulator can also be understood to mean a simulation unit preferentially configured to impose the processed radar signal on the simulated test scenario by modifying one or more radar data packets.

A “conversion apparatus” within the meaning of the present invention is in particular an apparatus which converts an analog radar signal into a digital radar data packet which characterizes the analog radar signal or, respectively, converts a digital radar data packet into an analog radar signal which characterizes the digital radar data packet. Preferably, the conversion apparatus is configured to receive the analog radar signal, or digital radar data packet respectively, and generate a corresponding digital radar data packet/corresponding analog radar signal. An analog/digital converter or digital/analog converter respectively can for instance be a conversion apparatus.

A “data processing apparatus” within the meaning of the present invention is in particular an apparatus which is preferably configured to process digital data, for instance reproduce, store, modify, combine, link, manage, etc. A data processing apparatus can be designed for instance as a computer or computer system, in particular with at least one processor and at least one memory.

A “time delay device” within the meaning of the present invention is in particular a device, for instance a software module, which receives a radar data packet and then provides it again after a time delay. A time delay device can be designed for instance as a software function in which at least the radar data packet is assumed as an input variable and which outputs the delayed radar data packet as an output variable.

A “modification device” within the meaning of the present invention is in particular a device, for instance a software module, which receives a radar data packet and performs a modification on the radar data packet, in particular on the basis of a test scenario. A modification device can be designed for instance as a software module in which at least the radar data packet is assumed as an input variable and which alters the radar data packet in such a way that the modified radar data packet characterizes at least a part, e.g. one object, of a test scenario.

The invention is based in particular on the approach of converting one or more received analog radar signals, which were preferably emitted by a radar sensor, into at least one or more corresponding digital radar data packets; i.e. a digital representation of the one or more analog radar signals, and providing, in particular generating, a plurality of delayed radar data packets based on the one or multiple radar data packets by means of a time delay device, in particular a so-called digital delay line. This is particularly advantageous, as only one single time delay device in particular can thereby provide a delayed radar data packet for each object to be emulated of a test scenario, in particular a virtual test scenario, whereby the time delay emulates a transit time of an originally analog radar signal and thus characterizes an in particular virtual distance of the object to the radar sensor. Moreover, preferably a modification device is configured to adapt such delayed radar data packets with respect to the test scenario, in particular by modifying the digital radar data packets so as to correspond to the modulation of the corresponding analog radar signals via the reflection on one or more objects of the test scenario. This enables a rapid, in particular real-time, provision of the test scenario in a digital data processing apparatus, in particular based on at least one analog radar signal.

Furthermore, a plurality of radar targets; i.e. objects of the test scenario, can also be readily emulated at different positions in the azimuth plane and/or elevation plane alternatively or additionally to the setting of the virtual distance by the time delay device, preferably by the modified radar data packets being distributed to the at least two transmitter devices or respectively allotted to the at least two transmitter devices, in particular prior to the second conversion apparatus converting the modified radar data packets distributed to the transmitter devices into analog processed radar signals. Alternatively or additionally, the elongation of individual targets along the azimuth plane and/or elevation plane can also be emulated, preferably by a modified radar data packet being distributed to at least two adjacent transmitter devices or respectively allotted to at least two adjacent transmitter devices, in particular prior to the second conversion apparatus converting the modified radar data packet distributed to the transmitter devices into an analog processed radar signal.

All in all, the invention allows simple and flexible imaging of radar targets, particularly with respect to the number of emulable radar target objects and/or possible target distances or target positions respectively.

In one preferential embodiment of the invention, the time delay device is configured to delay the at least one digital radar data packet multiple times by one or more, in particular different, predefined time periods. The time delay device can thereby preferentially delay the digital radar data packet once for each object to be emulated in the test scenario by a predefined time period, preferably based on the target virtual distance of the object from the radar sensor, whereby each of the delayed radar data packets is directly modified by the modulation device during the further processing so as to map a respective emulated object. Alternatively or additionally, the digital radar data packet can be delayed multiple times by a predefined period of time, in particular the same time period, so that at least two of the delayed radar data packets at the desired time delay are in particular combined and modified by the modulation device to form one delayed radar data packet in each case during further processing, preferably based on the target virtual distance of the object from the radar sensor. This thereby enables the flexible adaptation of the radar data packet's time delay, for example to a change in the test scenario.

In a further preferential embodiment of the invention, the time delay device is configured to provide at least one of the plurality of delayed radar data packets by re-delaying a radar data packet already having been previously delayed. To that end, the time delay device is preferably configured to again receive the previously delayed radar data packet and delay it by a predefined, in particular the same, time delay. Alternatively or additionally, the time delay device can comprise a plurality of time delay modules configured to delay the digital radar data packet sequentially, in particular by one or more predefined time periods, and respectively provide a delayed radar data packet. The complexity of the time delay device can thereby be advantageously reduced and/or delayed radar data packets can be provided in a particularly reliable manner.

In a further preferential embodiment of the invention, the time delay device is configured to at least temporarily store the at least one digital radar data packet and provide it at intervals characterized by the predefined time period or the plurality of predefined time periods. In particular, the time delay device can withhold the digital radar data packet and repeatedly release it for further processing after time periods which preferably depend on the target virtual distances of the test scenario objects from the radar sensor. The complexity of the time delay device can thereby be advantageously even further reduced and the provision of the delayed radar data packets can be synchronized flexibly and/or as needed.

According to a further preferential embodiment of the invention, the time delay device is configured to delay the radar data packet in consideration of a processing time required to further process the radar data packet in the data processing apparatus. Preferably, the time delay device is moreover configured to adapt the time delay of the digital radar data packet to a change, in particular to fluctuations, in the cited processing time, in particular in consideration of the target virtual distances of the test scenario objects from the radar sensor. Thus, the time delay of the digital radar data packet effected by the time delay device can for example be reduced when due to an in particular increasing complexity of the virtual test scenario, an increase in the processing power required to simulate the test scenario is determined or at least conceivable. In so doing, latency-related time delays in the processing of the radar data packet can be offset, these which would otherwise adversely affect the precision of the virtual distances of the test scenario objects to the radar sensor.

In a further preferential embodiment, the data processing apparatus comprises a first data processing device which is configured to combine at least two of the plurality of radar data packets delayed by the delay device and provide them as further delayed radar data packets, in particular output to the modification device. In particular, the first data processing device is configured to provide a plurality of delayed radar data packets, on the basis of which the objects to be emulated, or the test scenario respectively, can be mapped, in particular after the respective modification by the modification device. The number of further delayed radar data packets provided by the first data processing device is thereby preferably independent of the number of delayed radar data packets provided by the time processing device. This enables a decoupling of the time delay device and the modification device such that the time delay device and/or modification device can be used and/or designed particularly efficiently.

In a further preferential embodiment of the invention, the data processing apparatus comprises a second data processing device which is configured to combine at least two of the radar data packets modified by the modification device and provide them as further modified radar data packets, in particular output to the second conversion apparatus. In particular, the second data processing device is configured to provide a plurality of further modified radar data packets, on the basis of which a predetermined distribution of the emulated objects is effected to the at least two transmitter devices, in particular following commensurate conversion by the second conversion apparatus. The number of further modified radar data packets provided by the second data processing device is thereby preferably independent of the number of modified radar data packets provided by the modification device. This enables free positioning and/or movement of emulated objects in the azimuth plane and/or the elevation plane relative to the radar sensor.

Preferably, the first and/or second data processing device comprises at least two data processing modules which are configured to combine in each case at least two of the delayed or respectively modified radar data packets substantially simultaneously, particularly in parallel. Thus, for one or more objects of the test scenario to be emulated, one respective data processing module can be provided which combines at least two of the delayed or respectively modified radar data packets together. Consequently, a respective radar data packet can be generated with a time delay corresponding to a distance of the object to be emulated from the radar sensor. Alternatively or additionally, radar data packets can be formed which enable a desired lateral positioning of the objects to be emulated with respect to the radar sensor.

The first and/or second data processing device can, however, also be configured to provide at least one of the delayed/modified radar data packets unchanged, in particular output them to the modification device or to the second conversion apparatus respectively.

In a further preferential embodiment of the invention, the first and/or the second data processing device is configured to repeatedly receive one of the delayed radar data packets provided by the delay device, or one of the modified radar data packets provided by the modification apparatus respectively, in particular in parallel to one another, as first input data and receive at least two radar data packets delayed by the time delay device, or modified by the modification device and already combined together respectively, as second input data and combine the first input data received with the second input data received and provide same as respective output data. Preferably, the further delayed radar data packets are provided at the modification device for modification, or respectively the further modified radar data packets at the second conversion apparatus for conversion into corresponding analog processed radar signals for transmission via the at least two transmitter devices on the basis of the output data. The delayed/modified radar data packets can thereby be flexibly adapted with regard to the test scenario or the spatial distribution of the objects to be emulated within the test scenario respectively.

To that end, the first and/or the second data processing device preferably comprises a plurality of data processing modules, each configured to receive and combine the first and second input data and provide them in each case as output data. Preferably, the number of data processing modules is given by the product of the number of delayed radar data packets provided by the time delay device and the number of the objects of the test scenario to be emulated, or by the product of the number of the objects of the test scenario to be emulated and the number of transmitter devices respectively. The data processing modules can thereby be advantageously formed by software or can be a software component which receives and processes the respective first and second input data and outputs the corresponding output data.

The output data of one of the multiple data processing modules can advantageously form the second input data of another of the multiple data processing modules so the further delayed radar data packets provided at the modification device, or respectively the further modified radar data packets provided at the second conversion apparatus, are cascaded. Alternatively, it is also possible to re-feed to the first and/or second data processing device, in particular a data processing module, the output data it already provided as the second input data so that the further delayed/modified radar data packets are generated iteratively.

In a further preferential embodiment of the invention, the first and/or second data processing device is configured to weight the radar data packets delayed by the time delay device, or the radar data packets modified by the modification device respectively, when combining them together. This thereby ensures virtually any time delays of the radar data packets or assigning of the radar data packets to the at least two transmitter devices respectively. For example, a modified radar data packet can be weighted and distributed to at least two adjacent transmitter devices such that the corresponding analog processed radar signal is received by the radar sensor at two different angles, in particular azimuth and/or elevation angles, and an elongation of the object is thus emulated.

In a further preferential embodiment of the invention, the radar target emulator comprises a receiving apparatus having at least two receiver devices configured to receive analog radar signals emitted by a radar sensor, wherein the first conversion device is configured to convert the analog radar signals, particularly in parallel, into corresponding digital radar data packets. The at least two receiver devices are in particular configured to receive modulated transmitted radar signals from the radar sensor in different transmission ranges, different frequencies and/or using different modulation methods. The corresponding digital radar data packets can then be processed by the data processing apparatus, in particular independently of one another and/or in parallel, so that a test scenario can also be digitally mapped to complex radar signals, in particular easily, flexibly and/or quickly.

A second aspect of the invention relates to a test bench, in particular for a vehicle, having a radar target emulator according to the first aspect of the invention. The at least substantially fully digital radar target emulator, which may have at least two receiver devices and at least two transmitter devices as applicable, thereby makes it possible to provide or respectively process spatially elongated and/or complex radar signals of a radar sensor in the test bench, and provide spatially resolved, particularly with regard to an azimuth plane and/or an elevation plane, processed radar signals at the radar sensor, whereby the test bench has no moving or respectively mechanical components. The test bench can thus be compactly implemented.

A third aspect of the invention relates to a method for digitally processing at least one analog radar signal comprising the steps: converting the at least one analog radar signal into at least one corresponding digital radar data packet; providing a plurality of delayed radar data packets on the basis of the at least one digital radar packet via a time delay device of a data processing apparatus; providing a plurality of modified radar data packets on the basis of the plurality of delayed radar data packets via a modification device of the data processing apparatus; providing at least one analog processed radar signal by converting the digital radar data packets processed by the data processing apparatus; and emitting the at least one analog processed radar signal.

The features and advantages described with respect to the first aspect of the invention and advantageous embodiment also apply, at least where technically sensible, to the second and third aspects of the invention and advantageous embodiment and vice versa.

The invention is explained in greater detail below on the basis of non-limiting exemplary embodiments as depicted in the figures. Shown therein at least partially schematically:

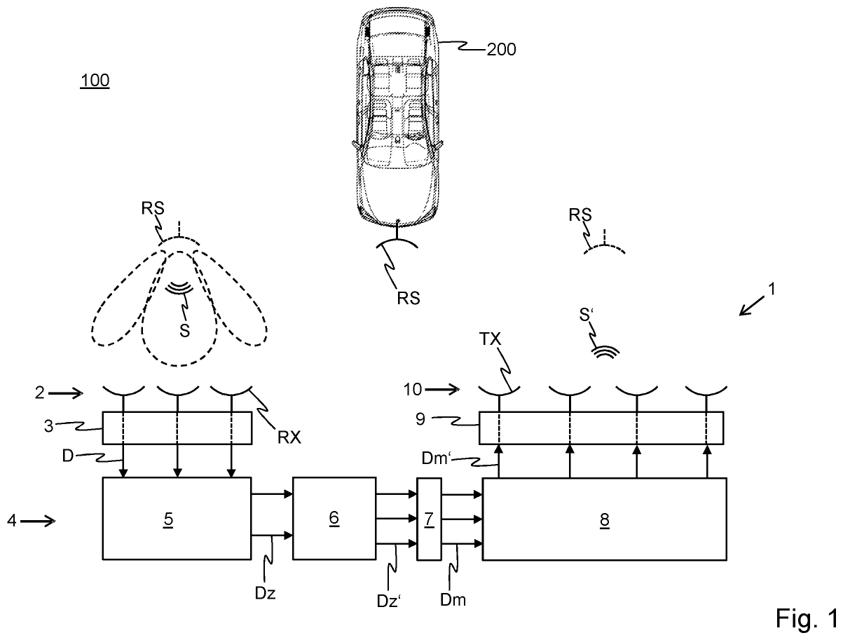

FIG. 1 a preferential exemplary embodiment of a test bench; and

FIG. 2 a preferential exemplary embodiment of a data processing device.

FIG. 1 shows a preferential exemplary embodiment of a test bench 100 which is preferably configured for testing a vehicle 200 having a radar sensor RS for transmitting and receiving analog radar signals S, S′ and comprises a radar target emulator 1. For reasons of clarity, the elements in the figure which are the same are thereby only identified once by a reference numeral, and the radar sensor RS is respectively depicted once using dashes with respect to the transmission of radar signals S and the receiving of radar signals S′ processed by the radar target emulator 1.

The radar target emulator 1 is preferably configured to influence, in particular modify, radar signals S emitted by the radar sensor RS based on a test scenario, for instance a traffic situation, such that the radar signals S′ processed in this way and transmitted back to the radar sensor RS represent the test scenario. As a result, components of the vehicle 200, their function being based on reflected radar signals 5′, can in this way be tested.

The radar sensor RS preferably has a plurality of transmission ranges RS1, RS2 which are in particular at least substantially spatially separated and/or which are symmetrical with respect to an axis, in particular a longitudinal axis of a vehicle. The radar signals S emitted in transmission ranges RS1, RS2 thereby propagate in different directions and can exhibit different frequencies or be modulated by different modulation methods so that objects which reflect the radar signals S back to the radar sensor are assigned to the different transmission ranges RS1, RS2 and/or can be detected at high spatial resolution.

The radar target emulator 1 in the example shown comprises a receiving apparatus 2, for instance an antenna array, preferably having at least two receiver devices RX, for instance three antennas distributed in a line or along a surface, configured to receive the analog radar signals S emitted by the radar sensor S and connected to a first conversion apparatus 3, which digitizes the received radar signals S and outputs them as corresponding digital radar data packets D to a data processing apparatus 4, in particular a time delay device 5. Preferably one digital radar data packet D is thereby provided for each received radar signal S, for instance by the first conversion apparatus 3 being designed as an analog/digital converter, wherein the various digital radar data packets D provided are for example each assigned to one transmission range RS1, RS2.

The time delay device 5 is preferably configured to receive the provided digital radar data packets D and repeatedly output them at different time delays to a first data processing device 6. The time delay device 5 performs the time delay, in particular by one or more predetermined time periods, for each of the digital radar data packets D provided, preferably substantially simultaneously and/or in parallel; i.e. three times in the shown example. For the sake of clarity, the delayed radar data packets Dz then provided by the time delay device 5 are only shown here for one of the provided digital radar data packets D.

The first data processing device 6 is in particular suitable to providing further delayed radar data packets Dz′ based on the delayed radar data packets Dz, for instance by combining at least two of the delayed radar data packets Dz provided. Based on the combining of at least two of the delayed radar data packets Dz provided, additional delayed radar data packets Dz′ can thus in particular be generated. In the example shown, the two delayed radar signals Dz provided by the time delay device 5 are provided unchanged by the first data processing apparatus 6 as further delayed radar data packets Dz′ along with further delayed radar data packet Dz′ based, for instance, on a combination of the two delayed radar data packets Dz provided by the time delay device 6. The number of radar data packets Dz provided by time delay device 5 can therefore differ from the number of further delayed radar data packets Dz′ provided by the first data processing device 6.

The first data processing device 6 is in particular configured to provide a sufficient number of further delayed radar data packets Dz′ on the basis of the combination of at least two of the radar data packets Dz provided by the time delay device 5 so as to enable a mapping of the test scenario via the modification of the radar data packets Dz′ by the modification device 7. In particular, the first data processing device 6 provides a respective further delayed radar data packet Dz′ for each object of the test scenario to be emulated based on the combination of at least two of the radar data packets Dz provided by the time delay device 5, whereby each of these objects is assigned a virtual distance dependent on the time delay of the respectively provided radar data packet Dz′.

After the modification based on the test scenario as described, the modified radar data packets Dm provided by the modification device 7 are received by a second data processing device 8 and combined together where applicable in order to be output as an analog processed radar signal S′ to a transmission apparatus 10, for instance an antenna array, having at least two transmitter devices TX, in the present example for instance four antennas arranged in a line or along a surface, after being converted by a second conversion apparatus 9.

The modified radar data packets Dm, preferably each of which characterize an emulated object of the test scenario, are output or respectively provided by the second data processing apparatus 8 as further modified radar data packets Dm′, particularly under consideration of a spatial distribution of the emulated objects in the test scenario. The output or provision respectively ensues for example such that the further modified radar data packets Dm′ or the corresponding analog processed radar signals S′ respectively are distributed to the transmitter devices TX or respectively assigned to the transmitter devices TX according to an arrangement of the emulated objects in the test scenario. The number of modified radar data packets Dm provided by modification device 7 can therefore differ from the number of further modified radar data packets Dm′ provided subsequent processing in the second data processing device 8 or the corresponding analog processed radar signals S′ respectively. The number of modified radar data packets Dm provided by the modification device 7 thereby preferably corresponds to the number of test scenario objects to be emulated, whereas the number of further modified radar data packets Dm provided by the second data processing device 8, or the corresponding analog processed radar signals S′ respectively, is contingent on the target spatial lateral distribution of the emulated objects.

The provision or respectively output of the further modified radar data packets Dm′ by the second data processing device 8 to the transmitter device(s) TX thereby enables in particular the imaging of a simulated object relative to the radar sensor RS at a specific angle, in particular azimuth angle and/or elevation angle, determined by the spatial position of the transmitter devices TX. The second data processing device 8 can also be configured to provide at least one of the provided modified radar data packets Dm to a plurality of, in particular adjacent, transmitter devices TX, whereby an elongation of the emulated object characterized by the modified radar data packet Dm is mapped with respect to the radar sensor RS. It is likewise possible to dynamically assign the modified radar data packets Dm to the transmitter devices TX so that movement of the corresponding emulated objects is mapped.

The data processing apparatus 4 preferably comprises at least one processor and at least one memory so that the time delay device 5, the first and second data processing device 6, 8 and the modification device 7 can be implemented as software modules on the data processing apparatus 4. The digital radar data packets D, Dz, Dz′, Dm, Dm′ can be at least temporarily stored in the memory in between said digital radar data packets D, Dz, Dz′, Dm, Dm′ being processed by the cited software modules on the processor. This enables a flexible, economical, reliable and fast display of the test scenario relative the radar sensor RS via the analog processed radar signals S′ based on the transmitted analog radar signals S.

FIG. 2 shows a preferential exemplary embodiment of a data processing device 6, 8 which receives the provided digital radar data packets, in the example shown, delayed radar data packets Dz1, Dz2, Dz3, Dz4 provided by a time delay device 5, and is configured to combine at least two of the received radar data packets together and/or output same, in the example shown to a modification device 7. Alternatively, the data processing device 6, 8 can also receive and output modified radar data packets provided by the modification device 7 to a conversion apparatus. The data processing device 6, 8 shown can in particular be the first or second data processing device depicted in FIG. 1. For reasons of clarity, the elements in FIG. 2 which are the same are only identified once by a reference numeral.

The function of the data processing device 6, 8 is preferably equivalent to the function of a so-called switching matrix, in which signals at a plurality of inputs of the switching matrix are successively conveyed through individual matrix elements of the switching matrix and thereby processed, in particular divided, amplified or attenuated and/or combined.

Preferably, the data processing device 6, 8 operates in a cascade. To that end, the data processing device 6, 8 comprises a plurality of data processing modules 11, 11a, 11b, 11c, 11d, which each receive first and second input data E1, E2, combine them together where applicable, and provide or respectively output them as output data A. The first input data E1 is thereby in particular composed of one of the plurality of delayed radar data packets Dz1 Dz4 provided, and the second input data E2 is in particular composed of another of the radar data packets Dz1 Dz4 or at least two delayed radar data packets Dz1 Dz4 already combined together.

This is shown by way of example for the four data processing modules 11a-11d. The combination of the first and second input data E1, E2 is indicated by a black circle. The dotted lines illustrate the correlation between the delayed radar data packets Dz1 Dz4 provided by the time delay device 5 and the further delayed radar data packets Dz′ output to the modification device 7 by the data processing device 6, 8.

The first input data E1 from the second delayed radar data packet Dz2 and the second input data E2 from the first delayed radar data packet Dz1 are formed and combined in the first data processing module 11a and output to the second data processing module 11b as output data A. The output data A output by the first data processing module 11a forms the second input data E2 in the second data processing module 11b and the third delayed radar data packet Dz3 forms the first input data E1. The first and second input signals E1, E2 combined together in the second data processing module 11b are output to the third data processing module 11c as output data A and are in turn received from same as second input data E2. The combination of this second input data E2 and first input data E1, formed by the fourth delayed radar data packet Dz4, is ultimately output in the third data processing module 11c to the modification device 7 as a further delayed radar data packet Dz′. Thus, all told, the further delayed radar data packet Dz′ output as such contains portions of all four delayed radar data packets Dz1-Dz4.

In the fourth data processing module 11d, the first delayed radar data packet Dz1 forms the second input data E2 and the third delayed radar data packet Dz3 forms the first input data E1. The combination of the first and second input signals E1, E2 is output to the modification device 7 as output data A or as further delayed radar data packet Dz′ respectively. Thus, all told, the further delayed radar data packet Dz′ output as such only contains portions of the first and third delayed radar data packet Dz1, Dz3.

With respect to the example shown, the other data processing modules 11 not specified to any greater extent perform no operation on the delayed radar data packets Dz provided by the time delay device 5 or on combinations thereof. The further delayed radar data packet Dz′ output to the modification device 7 by the data processing device 6, 8 is therefore composed exclusively of the first delayed radar data packet Dz1.

It is understood by one skilled in the art that the above explanations relating to the data processing modules 11, 11a-11d are to be understood as purely exemplary and the data processing device 6, 8, in particular the data processing modules 11, also allow for any other combinations of delayed radar data packets Dz1 Dz4 as provided.

### LIST OF REFERENCE NUMERALS

1 radar target emulator
2 receiving apparatus
3 first conversion apparatus
4 data processing apparatus
5 time delay device
6 first data processing device
7 modification device
8 second data processing device
9 second conversion apparatus
10 transmission apparatus
11 data processing module
11a-11d first to fourth data processing module
100 test bench
200 vehicle
RS radar sensor
RS1, RS2 transmission ranges
RX receiver device
TX transmitter device
S analog radar signal
S′ processed analog radar signal
D digital radar data packet
Dz delayed radar data packet
Dz′ further delayed radar data packet
Dz1 Dz4 first to fourth delayed radar data packet
Dm modified radar data packet
Dm′ further modified radar data packet
E1, E2 first, second input data
A output data

What is claimed is:

1. A radar target emulator, comprising:
a first conversion apparatus configured to convert at least one analog radar signal into at least one digital radar data packet;
a data processing apparatus comprising a time delay device and a modification device, wherein the time delay device is configured to provide a plurality of delayed radar data packets based on the at least one digital radar data packet, and the modification device is configured to provide a plurality of modified radar data packets based on the plurality of delayed radar data packets;
a second conversion apparatus configured to provide processed analog radar signals by converting the at least one digital radar data packet processed by the data processing apparatus; and
a transmission apparatus comprising at least two transmitter devices configured to transmit the processed analog radar signals provided by the second conversion apparatus.

2. The radar target emulator according to claim 1, wherein the time delay device is further configured to delay the at least one digital radar data packet multiple times by one or more predefined time periods.

3. The radar target emulator according to claim 2, wherein the time delay device is further configured to re-delay at least one delayed radar packet in the plurality of delayed radar data packets.

4. The radar target emulator according to claim 2, wherein the time delay device is further configured to at least temporarily store the at least one digital radar data packet and provide it at the one or more predefined time periods.

5. The radar target emulator according to claim 1, wherein the time delay device is further configured to delay the at least one digital radar data packet an amount of time depending on a processing time required to further process the at least one digital radar data packet in the data processing apparatus.

6. The radar target emulator according to claim 1, wherein the data processing apparatus further comprises a first data processing device configured to combine at least two delayed radar data packets in of the plurality of delayed radar data packets delayed by the delay device, and provide them as combined further delayed radar data packets.

7. The radar target emulator according to claim 6, wherein the data processing apparatus comprises a second data processing device configured to combine at least two modified radar data packets in the plurality of modified radar data packets modified by the modification device and provide them as combined further modified radar data packets.

8. The radar target emulator according to claim 7, wherein the first data processing device and/or the second data processing device is configured to repeatedly:
receive at least one delayed radar data packet in the plurality of delayed radar data packets provided by the time delay device or receive at least one modified radar data packet in the plurality of modified radar data packets provided by the modification apparatus as first input data, and receive combined further delayed radar data packets delayed by the time delay device or combined further modified radar data packets modified by the modification device as second input data,
combine the received first input data and received second input data and provide the same as respective output data, and
provide the combined further delayed radar data packets at the modification device for modification or provide the combined further modified radar data packets at the second conversion apparatus for conversion into corresponding processed analog radar signals for transmission via the at least two transmitter devices based on the output data.

9. The radar target emulator according to claim 1, wherein the first data processing device and/or the second data processing device is configured to weight the plurality of radar data packets delayed by the time delay device or the plurality of modified radar data packets modified by the modification device when combining them together.

10. The radar target emulator according to claim 1, further comprising a receiving apparatus having at least two receiver devices configured to receive the at least one analog radar signal emitted by a radar sensor, wherein the first conversion apparatus is further configured to convert the at least one analog radar signal into the at least one digital radar data packet.

11. A test bench having a radar target emulator according to claim 1.

12. A method for digitally processing at least one analog radar signal comprising:
converting the at least one analog radar signaler into at least one digital radar data packet;
providing a plurality of delayed radar data packets based on the at least one digital radar packet via a time delay device a data processing apparatus;
providing a plurality of modified radar data packets based one the plurality of delayed radar data packets via a modification device of the data processing apparatus;
providing at least one processed analog radar signal by converting the at least one digital radar data packets by the data processing apparatus; and
emitting the at least one processed analog radar signal.
